(19) United States
(12) Patent Application Publication
(10) Pub. No.: US 2026/0328738 A1
(43) Pub. Date: Oct. 22, 2026

(54) LIQUID CHROMATOGRAPHY DEVICE AND LIQUID CHROMATOGRAPHY METHOD

(71) Applicant: HAMAMATSU PHOTONICS K.K., Hamamatsu-shi (JP)

(72) Inventors: Takafumi HIGUCHI, Shizuoka (JP); Tomomi KUBO, Shizuoka (JP); Yoshihiro MATSUMOTO, Shizuoka (JP)

(21) Appl. No.: 19/640,431

(22) Filed: Apr. 7, 2026

(30) Foreign Application Priority Data
Apr. 18, 2025 (JP) 2025-068757

(51) Int. Cl. G01N 30/74; B01D 15/14; G01N 30/02; G01N 30/16

(52) U.S. Cl. CPC G01N 30/74; B01D 15/14; G01N 30/16; G01N 2030/027

(57) ABSTRACT

A device includes: a liquid-feeder; a column; a sample injector; a detector; and circuitry, wherein the circuitry is configured to acquire first spectral data representing a distribution of values based on a measurement light for each of N time points and each of C measurement wavelengths on the basis of detection signals under a first measurement condition, acquire second spectral data representing a distribution of values based on a measurement light for each of the N time points and each of the C measurement wavelengths on the basis of detection signals under a second measurement condition, and determine whether the measurement light is detected for a single component or not at a detection time point based on the first spectral data and the second spectral data.

### CROSS-REFERENCE TO RELATED APPLICATIONS

This application is based upon and claims the benefit of priority from Japanese Patent Application No. 2025-068757, filed on Apr. 18, 2025, the entire contents of which are incorporated herein by reference.

### BACKGROUND

### Field

The present disclosure relates to a liquid chromatography device and a liquid chromatography method.

### Description of the Related Art

Japanese Non-Patent Literature by Masao Bonoshita and Takeshi Kanomata, “Detectors for High-Performance Liquid Chromatograph: Ultraviolet-Visible Absorbance Detector, Photodiode-Array Detector, Fluorescence Detector, Differential Refractive Index Detector, and Evaporative Light-Scattering Detector,” CHROMATOGRAPHY, Vol. 32, No. 1 (2011), discloses that, in the pharmaceutical field, high-performance liquid chromatography (HPLC) analysis is used for the purpose of testing or evaluating active pharmaceutical ingredients, pharmaceutical preparations, solvents, and the like. In HPLC analysis, column separation in which a liquid (or liquefied) sample is injected into a column (stationary phase) and separated into components is performed and absorbance, fluorescence intensity, conductivity, refractive index, evaporative light scattering, and the like are detected for each component, while each separated component passes through a flow cell together with a mobile phase.

### SUMMARY

According to a first aspect of an embodiment, there is provided a liquid chromatography device comprising: a liquid-feeder configured to feed a mobile phase; a column configured to separate a sample into a plurality of components, wherein the mobile phase is introduced into the column from the liquid-feeder; a sample injector configured to inject the sample into the column; a detector configured to detect, using a plurality of measurement wavelengths, measurement light derived from the plurality of components obtained in a separation process of the column, and to output detection signals; and circuitry configured to analyze the detection signals, wherein the circuitry is configured to: acquire first spectral data representing a distribution of values based on the measurement light for each of N (N is an integer of 2 or more) time points and each of C (C is an integer of 2 or more) measurement wavelengths on the basis of the detection signals output under a first measurement condition; acquire second spectral data representing a distribution of values based on the measurement light for each of the N time points and each of the C measurement wavelengths on the basis of the detection signals output under a second measurement condition; and determine whether the measurement light is detected for a single component or not at a detection time point based on the first spectral data and the second spectral data.

Alternatively, according to a second aspect of an embodiment, there is provided a liquid chromatography method comprising: feeding a mobile phase; injecting a sample into a column; introducing the mobile phase into the column; separating the sample into a plurality of components; detecting, using a plurality of measurement wavelengths, measurement light derived from the plurality of components obtained in a separation process of the column; outputting detection signals; and analyzing the detection signals, wherein the analyzing comprises: acquiring first spectral data representing a distribution of values based on the measurement light for each of N (N is an integer of 2 or more) time points and each of C (C is an integer of 2 or more) measurement wavelengths on the basis of the detection signals output under a first measurement condition; acquiring second spectral data representing a distribution of values based on the measurement light for each of the N time points and each of the C measurement wavelengths on the basis of the detection signals output under a second measurement condition; and determining whether the measurement light is detected for a single component or not at a detection time point based on the first spectral data and the second spectral data.

### BRIEF DESCRIPTION OF THE DRAWINGS

FIG. 1 is a schematic configuration diagram of a high-performance liquid chromatography system 1 according to an embodiment.

FIG. 2 is a schematic configuration diagram of a detection unit of FIG. 1.

FIG. 3 is a block diagram showing an example of a hardware configuration of an analysis unit 13 of FIG. 1.

FIG. 4 is a block diagram showing a functional configuration of the analysis unit 13 of FIG. 1.

FIG. 5 is a graph showing distributions of first spectral data and second spectral data acquired with a single component as a detection target.

FIG. 6 is a graph showing distributions of first spectral data and second spectral data acquired with a single component as a detection target.

FIG. 7 is a graph showing distributions of first spectral data and second spectral data acquired with a plurality of components as detection targets.

FIG. 8 is a graph showing distributions of intensity ratios calculated for a plurality of types of components as detection targets.

FIG. 9 is a diagram showing images of matrix data Y′ regenerated by the statistical value calculation unit 205 of FIG. 4 and component matrix data X′ derived by the statistical value calculation unit 205 of FIG. 4.

FIG. 10 is a diagram showing a data configuration of component matrix data X.

FIG. 11 is a flowchart showing a procedure of a liquid chromatography method according to the embodiment.

FIG. 12 is a schematic configuration diagram of a high-performance liquid chromatography system 1B according to a modification example.

FIG. 13 is a schematic configuration diagram of a detection unit 11B of FIG. 12.

FIG. 14 is a schematic configuration diagram of a detection unit 11C according to a modification example.

FIG. 15 is a graph showing a relationship between the number of separations and an evaluation value plotted by the analysis unit 13 according to a modification example.

### DETAILED DESCRIPTION

In the following description, with reference to the drawings, the same reference numbers are assigned to the same components or to similar components having the same function, and overlapping description is omitted.

Hereinafter, embodiments of the present invention will be described in detail with reference to the accompanying drawings. In the description, the same elements or elements having the same functions are denoted by the same reference signs and redundant descriptions thereof will be omitted.

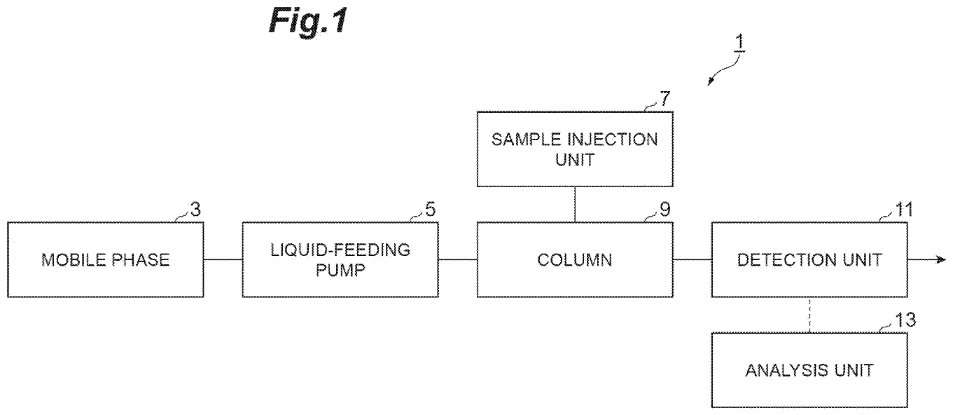

FIG. 1 is a schematic configuration diagram of a high-performance liquid chromatography (HPLC) system 1, which is a liquid chromatography device according to an embodiment. The HPLC system 1 is a device for generating data obtained by quantitatively analyzing or qualitatively analyzing components of compounds included in a sample including a liquid or a liquefied sample. The HPLC system 1 includes a mobile phase 3, a liquid-feeding pump (liquid-feeding unit) 5, a sample injection unit 7, a column (stationary phase) 9, a detection unit 11, and an analysis unit 13. In FIG. 1, flows of the sample and the mobile phase between the constituent elements are indicated by solid lines, and flows of signals between the constituent elements are indicated by dotted lines.

The mobile phase 3 is a liquid for separating a plurality of components included in the sample, and is held in a container. As the mobile phase 3, a buffer solution, water, polar solvents such as acetonitrile, and nonpolar solvents such as hexane and chloroform are used. The liquid-feeding pump 5 is provided between the container holding the mobile phase 3 and the column 9, and feeds the mobile phase 3 at a constant flow rate (speed) toward the detection unit 11 via the column 9. The sample injection unit 7 injects the sample into the column 9. As the sample injection unit 7, for example, an autosampler or a manual injector is used. A sample including a plurality of components is injected into the column 9 by the sample injection unit 7. The column 9 is a portion into which the mobile phase is introduced and in which the injected sample is separated into a plurality of components, and is a tubular member made of stainless steel or resin and filled with a column packing material that functions as a stationary phase. As the packing material filled into the column 9, fine particles of silica gel or polymer whose surfaces are chemically modified are used. The plurality of components in the sample are separated in the column 9 due to differences in interaction with the stationary phase and the mobile phase, and are fed to the detection unit 11 together with the mobile phase. The detection unit 11 is a portion that detects measurement light for the plurality of components obtained in a separation process of the column 9 using a plurality of measurement wavelengths (details will be described below). The analysis unit 13 is a device electrically connected to the detection unit 11 and configured to analyze detection signals output from the detection unit 11 (details will be described below).

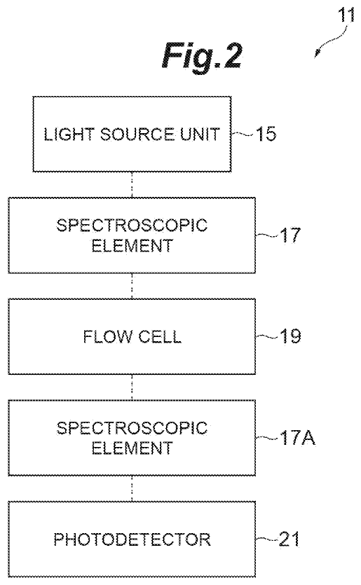

FIG. 2 is a schematic configuration diagram of the detection unit 11 of FIG. 1. As shown in FIG. 2, the detection unit 11 includes a light source unit 15, a spectroscopic element 17, a flow cell 19, a spectroscopic element 17A, and a photodetector 21. In FIG. 2, optical paths between the respective components are indicated by dotted lines.

The light source unit 15 irradiates a plurality of components separated from the sample by the column 9 with excitation light having a desired wavelength range including at least an ultraviolet wavelength range. For example, the light source unit 15 is a light source device such as a xenon (Xe) lamp. Here, the light source unit 15 may be a wavelength-variable light source or a wavelength-sweeping light source that switches excitation light among a plurality of wavelength bands and radiates excitation light of a predetermined single wavelength range (measurement wavelength). In this case, the spectroscopic element 17 to be described below may be omitted.

The spectroscopic element 17 is provided between the light source unit 15 and the flow cell 19, and is an element such as a grating or a prism that spectrally disperses the excitation light emitted from the light source unit 15 toward the flow cell 19. By changing an angle of the spectroscopic element 17, excitation light of any single wavelength range (measurement wavelength) is selectively output from excitation light having a desired wavelength region.

The flow cell 19 is a flow path through which the mobile phase including a plurality of components fed from the column 9 passes at a constant flow rate (speed). The flow cell 19 has, for example, a tapered flow path. While the mobile phase passes through the flow cell 19, excitation light radiated by the light source unit 15 and spectrally dispersed by the spectroscopic element 17 is incident on the flow cell 19.

The spectroscopic element 17A is provided between the flow cell 19 and the photodetector 21, and is an element such as a grating or a prism that spectrally disperses fluorescence (measurement light) generated from the plurality of components in accordance with irradiation of excitation light toward the photodetector 21. The spectroscopic element 17A receives fluorescence from the flow cell 19 and spectrally disperses and outputs fluorescence of a plurality of single wavelength ranges (measurement wavelengths).

The photodetector 21 detects fluorescence (measurement light) at each of the plurality of fluorescence wavelengths spectrally dispersed by the spectroscopic element 17A, and outputs detection signals indicating fluorescence intensities for the plurality of fluorescence wavelengths. As the photodetector 21, for example, a photodiode array having a plurality of pixels or the like is used. The photodetector 21 detects fluorescence at each of the plurality of fluorescence wavelengths with the respective pixels and outputs detection signals indicating intensities for each pixel.

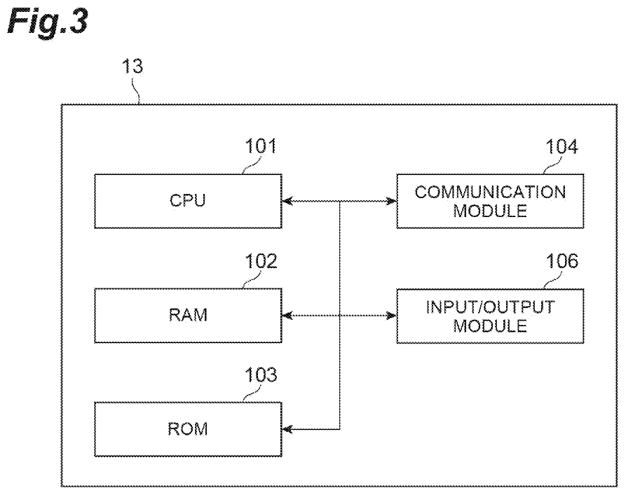

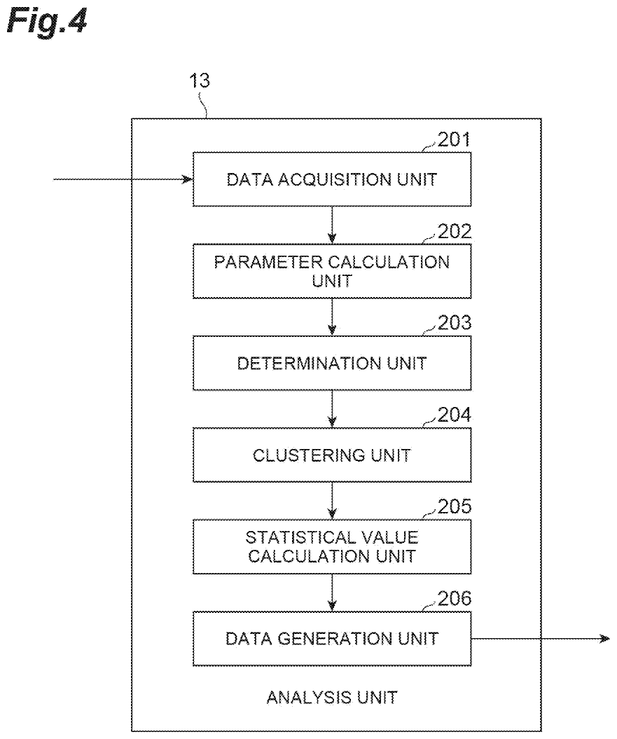

Next, a configuration of the analysis unit 13 will be described with reference to FIGS. 3 and 4. FIG. 3 is a block diagram showing an example of a hardware configuration of the analysis unit 13, and FIG. 4 is a block diagram showing a functional configuration of the analysis unit 13.

As shown in FIG. 3, the analysis unit 13 is physically a computer or the like including a central processing unit (CPU) 101 as a processor, a random-access memory (RAM) 102 or a read-only memory (ROM) 103 as a recording medium, a communication module 104, an input/output module 106, and the like, which are electrically connected to each other. The analysis unit 13 may include a display, a keyboard, a mouse, a touch-panel display, and the like as input/output devices, and may include a data recording device such as a hard disk drive or a semiconductor memory. Moreover, the analysis unit 13 may include a plurality of computers.

As shown in FIG. 4, the analysis unit 13 includes, as functional constituent elements, a data acquisition unit 201, a parameter calculation unit 202, a determination unit 203, a clustering unit 204, a statistical value calculation unit 205, and a data generation unit 206. Each functional unit of the analysis unit 13 shown in FIG. 4 is implemented by reading programs onto hardware such as the CPU 101 and the RAM 102, operating the communication module 104, the input/output module 106, and the like under the control of the CPU 101, and reading and writing data from and to the RAM 102. The CPU 101 of the analysis unit 13 executes the computer program to cause each functional unit of FIG. 4 to function, and sequentially executes a process corresponding to a liquid chromatography method to be described below. The CPU 101 may be implemented as a standalone hardware component or may be implemented in programmable logic such as an FPGA as a soft processor. The RAM and the ROM may also be single pieces of hardware, or may be incorporated in programmable logic such as an FPGA. Various types of data necessary for execution of the computer program, and various types of data generated by execution of the computer program, are all stored in internal memories such as the ROM 103 and the RAM 102, or in a storage medium such as a hard disk drive. Hereinafter, functions of the functional constituent elements of the analysis unit 13 will be described in detail.

The data acquisition unit 201 acquires, at least, first spectral data based on detection signals for a plurality of measurement wavelengths that are continuously output from the photodetector 21 at predetermined time intervals under a first measurement condition, and second spectral data based on detection signals for the plurality of measurement wavelengths that are continuously output from the photodetector 21 at predetermined time intervals under a second measurement condition. That is, as the first measurement condition, the data acquisition unit 201 acquires the first spectral data that is a distribution of fluorescence intensities for each of N (N is an integer of 2 or more) time points at the predetermined time intervals and each of C (C is an integer of 2 or more) measurement wavelengths, in a state in which the light source unit 15 and the spectroscopic element 17 set a condition under which light is switched to excitation light having a first excitation wavelength characteristic and radiated to the flow cell 19. In addition, the predetermined time intervals need not be constant. Moreover, the spectral data may be acquired on the basis of only detection signals at times when components overlap. C array data items for each of the N time points included in the spectral data are data obtained by spectrally measuring distributions of fluorescence intensity values at the C measurement wavelengths for each of the N time points in the detection unit 11. At this time, the number N of time points of the acquired spectral data (the number N of time points constituting the spectral data) is designated in advance so that the number N of time points is equal to or greater than the maximum possible number of components that may be included in the sample. Moreover, the number C of array data items to be acquired (the number C of observed fluorescence measurement wavelengths) is designated in advance so that the number C of array data items is equal to or greater than the maximum possible number of components that may be included in the sample. Furthermore, as the second measurement condition, the data acquisition unit 201 acquires second spectral data that is a distribution of fluorescence intensities for the above-described N time points and the above-described C measurement wavelengths, in a state in which a condition under which the light source unit 15 and the spectroscopic element 17 radiate excitation light having a second excitation wavelength characteristic different from the first excitation wavelength characteristic to the flow cell 19 by switching the light to the excitation light is set. At this time, because the mobile phase to be fed moves through the flow cell 19 over a period of several tens of seconds to several minutes, the data acquisition unit 201 can acquire detection signals from the photodetector 21 for each of the two excitation wavelength characteristics by radiating the excitation light from the light source unit 15 according to switching between the first excitation wavelength characteristic and the second excitation wavelength characteristic during that period. In addition, the data acquisition unit 201 may further switch the excitation light of excitation wavelength characteristics to acquire three or more of spectral data items.

The parameter calculation unit 202 generates first matrix data Y₁ and second matrix data Y₂ by arranging intensity values at N time points constituting each of the C array data items in parallel in one dimension on the basis of the first spectral data and the second spectral data and acquires an index parameter on the basis of a distribution of fluorescence intensities for the plurality of measurement wavelengths at one time point (a predetermined time point) among the N time points in the first matrix data Y₁ and a distribution of fluorescence intensities for the plurality of measurement wavelengths at the one time point in the second matrix data Y₂. The index parameter indicates an evaluation value obtained by evaluating whether or not the one time point is a single-component detection time point at which measurement light for a single component is detected. That is, the parameter calculation unit 202 calculates the index parameter on the basis of ratios between the intensity values at each of the C measurement wavelengths in the first matrix data Y₁ and an intensity values at each of the C measurement wavelengths in the second matrix data Y₂. More specifically, for one time point among the N time points, the parameter calculation unit 202 calculates ratios rᵢ (i is an integer equal to or greater than 1 and equal to or less than C) of intensity values of the C measurement wavelengths between the two matrix data items Y₁ and Y₂, calculates an average value rₐᵥₑ of the ratios rᵢ of the intensity values, and calculates an index parameter metric1 for the one time point using the following formula (1). Likewise, the parameter calculation unit 202 calculates the index parameter metric1 related to each of the N time points. Moreover, the parameter calculation unit 202 may acquire the average value rₐᵥₑ by calculating a ratio between a sum of intensity values at the C measurement wavelengths in the first matrix data Y₁ and a sum of intensity values at the C measurement wavelengths in the second matrix data Y₂, or may acquire the average value rₐᵥₑ by calculating a weighted average.

$$\begin{matrix}[ Math . 1 ] & \\ metric 1 = {\sum }_{i = 1}^{C} {( {r}_{i} - {r}_{ave} )}^{2} & ( 1 )\end{matrix}$$

Here, the meaning of the index parameter calculated by the parameter calculation unit 202 will be described.

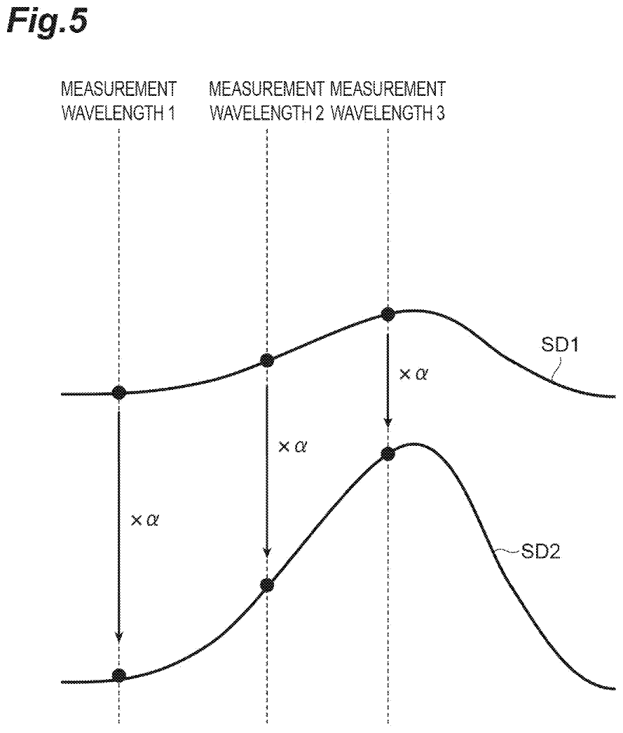

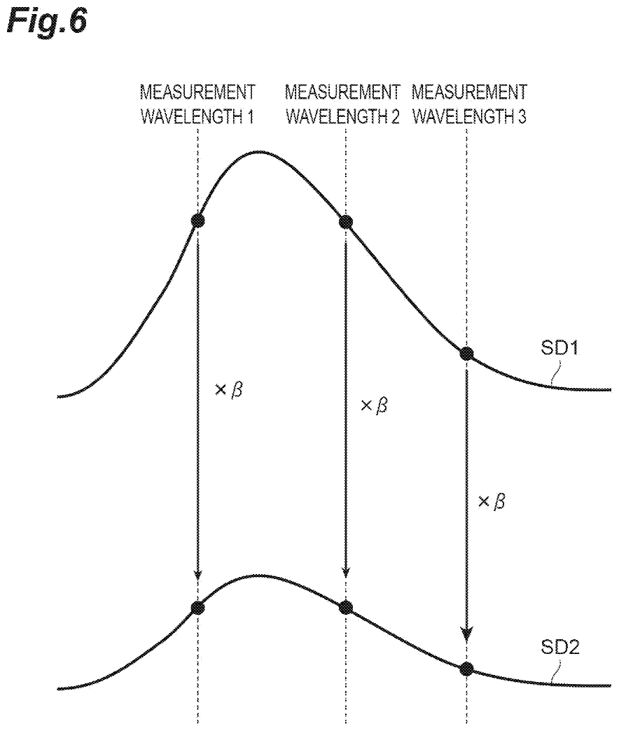

FIG. 5 is a graph showing distributions of first spectral data SD1 and second spectral data SD2 acquired for time points at which measurement light for only a component “Component A” is detected (single-component detection time points). As shown, in spectral data for single-component detection time points, a ratio rᵢ between the first spectral data SD1 and the second spectral data SD2 at each of three measurement wavelengths, i.e., “measurement wavelength 1,” “measurement wavelength 2,” and “measurement wavelength 3,” tends to be substantially constant at a value α regardless of the measurement wavelength. Moreover, FIG. 6 is a graph showing distributions of first spectral data SD1 and second spectral data SD2 acquired for time points at which measurement light for only a dye of “Component B,” which is different from “Component A,” is detected. As described above, in spectral data for such single-component detection time points for different types of components, a ratio rᵢ between the first spectral data SD1 and the second spectral data SD2 at each of the three measurement wavelengths, i.e., “measurement wavelength 1,” “measurement wavelength 2,” and “measurement wavelength 3,” tends to be substantially constant at a value β (≠α) regardless of the measurement wavelength, and the value β tends to differ according to each type of component of a measurement target.

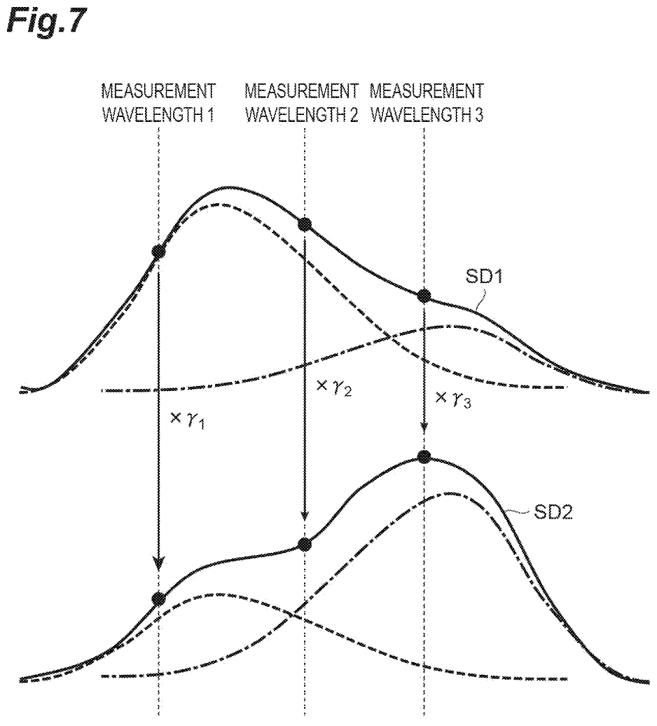

On the other hand, FIG. 7 is a graph showing distributions of first spectral data SD1 and second spectral data SD2 acquired for time points at which two types of components, “Component A” and “Component B,” are detected. In spectral data at time points at which a plurality of types of components are detected, ratios rᵢ between the first spectral data SD1 and the second spectral data SD2 at the three measurement wavelengths, i.e., “measurement wavelength 1,” “measurement wavelength 2,” and “measurement wavelength 3,” tend to take different values γ₁, γ₂, and γ₃.

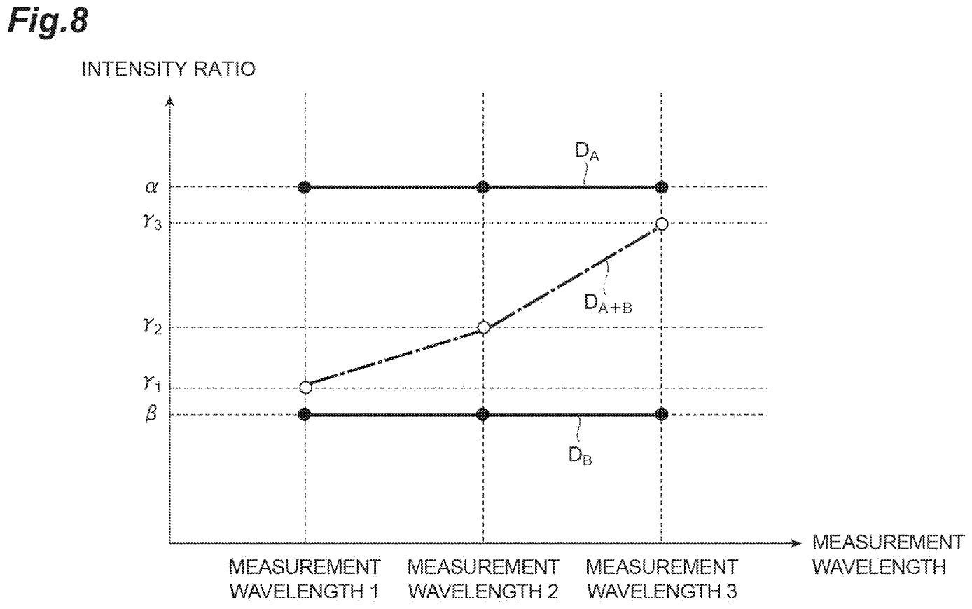

As shown in FIG. 8, with respect to the distribution of the ratio ri for each measurement wavelength, a distribution DA at a time point at which only “Component A” is detected is substantially constant at the value α, a distribution DB at a time point at which only “Component B” is detected is substantially constant at the value β, and a distribution DA+B at a time point at which two components, “Component A” and “Component B,” are detected varies among values γ1 to γ3. According to these properties, it can be understood that the smaller the value of the index parameter metric1, the higher the possibility that the time point will be a single-component detection time point, and that, in such a case, the average value rₐᵥₑ indicates the type of the single component detected at that time point.

On the basis of the index parameter calculated for each time point included in the N time points, the determination unit 203 determines whether or not each of the N time points is a single-component detection time point. As an example, the determination unit 203 determines that a time point with an index parameter less than or equal to a threshold is a single-component detection time point, and determines that a time point with an index parameter greater than the threshold is not a single-component detection time point. The threshold may be a value set in advance by a user or may be determined by the determination unit 203. In addition, when the threshold is determined by the determination unit 203, the threshold may be determined automatically by the determination unit 203 (for example, in accordance with a histogram of index parameters or the like), or may be determined by the determination unit 203 in accordance with parameters input from the user.

The clustering unit 204 reads the C array data items for each of the N time points acquired by the data acquisition unit 201, and executes clustering on intensity values at the C measurement wavelengths for a plurality of time points that are determined by the determination unit 203 to be single-component detection time points.

At this time, the clustering unit 204 clusters the plurality of time points into L (L is an integer equal to or greater than 2 and equal to or less than N−1) time-point groups on the basis of the average value rₐᵥₑ of the intensity value ratios rᵢ calculated by the parameter calculation unit 202 in relation to the plurality of time points determined to be single-component detection time points. At this time, the number L of time-point groups after clustering is designated in advance so that the number L of time-point groups is equal to or greater than the maximum possible number of components that may be included in the sample. For example, the clustering unit 204 clusters the plurality of time points into L time-point groups, each of which is a time interval including consecutive time points, using a k-means method. Here, the number L of time-point groups to be clustered by the clustering unit 204 is set in advance as a parameter stored within the analysis unit 13 in correspondence with the number of types of components that may be present in the sample. Also, the clustering unit 204 regenerates matrix data Y, in which intensity values of the C array data items are arranged in parallel in one dimension, by dividing the matrix data Y into cluster matrices for each of the L time-point groups. The number L of time-point groups to be clustered by the clustering unit 204 may be set in advance according to the types of measurement wavelengths or the number (C) of measurement wavelengths. Moreover, the number L of time-point groups to be clustered by the clustering unit 204 may be set independently of these.

By clustering performed by the clustering unit 204, dominant time regions of separated components can be grouped together. For example, even when component A exists in a temporally shorter range than component B, a dominant time region of component A and a dominant time region of component B can be grouped separately. Moreover, even when an amount of component A is smaller than that of component B, a dominant time region of component A and a dominant time region of component B can be grouped separately.

The statistical value calculation unit 205 obtains a mixing matrix (separation information) A for generating K (K is an integer equal to or greater than 2 and equal to or less than C) component data items indicating distributions for respective K components from the C array data items on the basis of the L cluster matrices obtained for the sample. In general, a relationship between matrix data Y, which is an observed value matrix, and component matrix data X in which K component data items are arrayed in parallel in one dimension for each time point is expressed by the following formula using the mixing matrix A.

Y=AX

Here, Y denotes matrix data of C rows and N columns, A denotes matrix data of C rows and K columns, and X denotes matrix data of K rows and N columns. In contrast, if values of the mixing matrix A are obtained, the component matrix data X can be derived by using an inverse matrix A⁻¹ of the mixing matrix A and the matrix data Y according to the following formula (this process is referred to as unmixing).

X=A⁻¹Y

Here, the statistical value calculation unit 205 regenerates matrix data Y′ by compressing the matrix data Y generated by the parameter calculation unit 202 for each time-point group clustered by the clustering unit 204. Specifically, the statistical value calculation unit 205 calculates statistical values for fluorescence intensities of each row of the matrix data Y for each time-point group of the clustered cluster matrices, and compresses the time-point group of each row into one data item having the calculated statistical value. Thereby, the statistical value calculation unit 205 regenerates matrix data Y′, which is matrix data of C rows and L columns. As the statistical value, the statistical value calculation unit 205 may calculate an average value based on an integrated value of fluorescence intensities, may calculate a mode of the fluorescence intensity, or may calculate a median of the fluorescence intensity.

Furthermore, the statistical value calculation unit 205 derives the mixing matrix A on the basis of the matrix data Y′ by using the property that the following formula including the mixing matrix A is also valid for the reproduced matrix data Y′ and the component matrix data X′ that is similarly compressed from the component matrix data X.

Y′=AX′

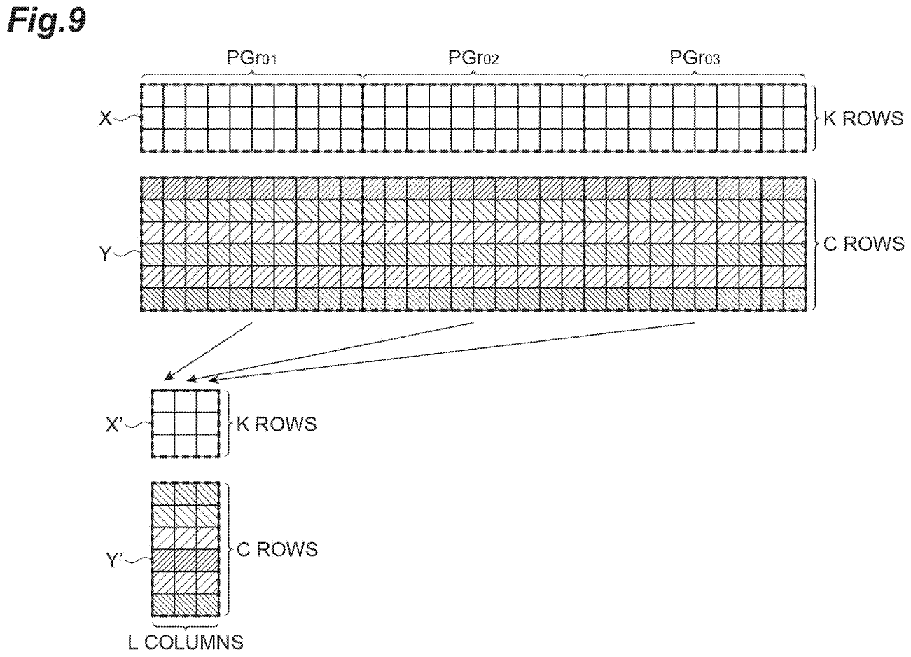

In FIG. 9, an image of the matrix data Y′ regenerated by the statistical value calculation unit 205 and the component matrix data X′ corresponding thereto is shown. One cell shown in FIG. 9 represents one element of the matrix data. As described above, the component matrix data X and the matrix data Y divided into three time-point groups PGr₀₁ to PGr₀₃ are data serving as the basis for being compressed into the three-column component matrix data X′ and matrix data Y′, using statistical values for each of the time-point groups PGr₀₁ to PGr₀₃ as representative values.

The statistical value calculation unit 205 derives the mixing matrix A on the basis of the matrix data Y′ as follows. That is, the statistical value calculation unit 205 sets an initial value for the mixing matrix A, calculates the following loss function (loss value) Los while sequentially changing the value of the mixing matrix A, and derives a mixing matrix A that reduces the value of the loss function Los. In addition, a regularization term such as an L1 norm λ|A| (λ is a coefficient indicating the degree to which the regularization term is emphasized) may be added to this loss function. More specifically, the statistical value calculation unit 205 sets an initial value of a candidate mixing matrix, and calculates loss values while sequentially changing values of the candidate mixing matrix A from the initial value; and identifies the candidate mixing matrix A having a value that reduces a loss value as the separation information. The statistical value calculation unit 205 calculates a difference between the matrix data Y′ and distribution of each of the K components X′ calculated from the matrix data Y′ and the candidate mixing matrix A

$$Los = {\sum }_{j}^{C} \frac{1}{a} {( {Y}^{′} - {AX}^{′} )}_{1 j}^{2} + {\sum }_{j}^{C} \frac{1}{b} {( {Y}^{′} - {AX}^{′} )}_{2 j}^{2} + {\sum }_{j}^{C} \frac{1}{c} {( {Y}^{′} - {AX}^{′} )}_{3 j}^{2} \qquad [ Math . 2 ]$$

In the above-described formula, j denotes a parameter indicating a row position of the matrix data (corresponding to a wavelength band of excitation light), a matrix subscript 1j indicates matrix data of a j-th row of a first cluster matrix, the matrix subscript 2j indicates matrix data of a j-th row of a second cluster matrix, and the matrix subscript 3j indicates matrix data of a j-th row of a third cluster matrix. Moreover, parameters a, b, and c indicate average values of statistical values of respective columns of the matrix data Y′.

As described above, the statistical value calculation unit 205 calculates a loss function with reference to statistical values of matrix data items Y′ for each of L cluster matrices obtained by a division process of the clustering unit 204, calculates the loss function Los on the basis of a sum of the L loss functions, and obtains the mixing matrix A on the basis of the loss function Los. At this time, the statistical value calculation unit 205 obtains the loss function Los by correcting the loss functions calculated for the L cluster matrices by dividing each loss function by the average values a, b, and c of the statistical values of the respective columns of the matrix data Y′, and then calculating a sum of the corrected loss functions. In addition, the statistical value calculation unit 205 may calculate the loss function for each of the L cluster matrices by correcting the row components for each measurement wavelength of a difference value Y′−AX′ by dividing them by statistical values corresponding to the respective measurement wavelengths.

In addition, the above-described formula can be generalized as follows. That is, the statistical value calculation unit 205 derives the mixing matrix A and the component matrix data X′ on the basis of the matrix data Y′ as follows. That is, the statistical value calculation unit 205 sets initial values for the mixing matrix A and the component matrix data X′, sequentially changes values of the mixing matrix A and the component matrix data X′, calculates a loss function (loss value) Los using the following formula, and derives the mixing matrix A and the component matrix data X′ that reduce the value of the loss function Los. In addition, a regularization term such as an L1 norm λ|A| (λ is a coefficient indicating the degree to which the regularization term is emphasized) may be added to this loss function. Moreover, calculation may be performed with a constraint that the mixing matrix A and the component matrix data X′ take non-negative values.

$$Los = {\sum }_{i}^{L} {Los}_{i} {\sum }_{i}^{L} {\sum }_{j}^{C} {{w}_{ij} ( {Y}^{′} - {AX}^{′} )}_{ij}^{2} \qquad [ Math . 3 ]$$

In the above-described formula, j denotes a parameter indicating a row position of the matrix data (corresponding to a measurement wavelength), and i denotes a parameter indicating a column position of the matrix data (corresponding to an i-th cluster). Moreover, wij denotes a weight of each element of the matrix data, and may be calculated from a value of each element or a standard deviation thereof. Moreover, it is possible not to consider the weight of each element by setting all wᵢⱼ to the same value. In addition, a formula obtained by setting average values of statistical values of respective columns of the matrix data Y′ in the above formula to a, b, c, . . . , and substituting w₁ⱼ=1/a, w₂ⱼ=1/b, and w₃ⱼ=1/c is identical to the previously described formula of the loss function Los.

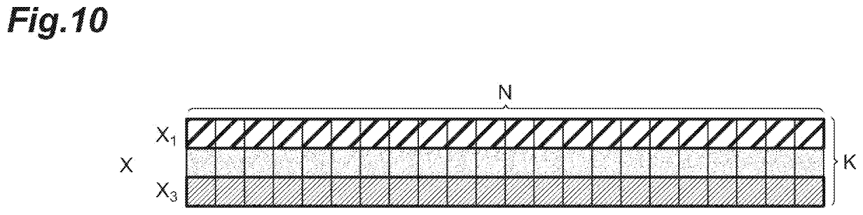

The data generation unit 206 generates K component data items by unmixing spectral data obtained by the data acquisition unit 201 for a sample using the mixing matrix A derived by the statistical value calculation unit 205. Specifically, the data generation unit 206 calculates the component matrix data X by applying an inverse matrix A⁻¹ of the mixing matrix A to the matrix data Y generated on the basis of C array data items by the clustering unit 204. In FIG. 10, a data configuration of the component matrix data X is shown. As described above, the component matrix data X has a size of K×N (K denotes the number of components, and N denotes the number of data points (times)), and is a matrix in which K component data items are each one-dimensionally arranged in a horizontally long manner. Here, assuming K=3, N time-point data items are arranged for each of the three component data items in the component matrix data X. Also, the data generation unit 206 acquires K component data items from the component matrix data X and outputs the acquired K component data items. The output destination at this time may be an output device of the analysis unit 13 such as a display or a touch panel display, or may be an external device connected to the analysis unit 13 so that data communication is possible.

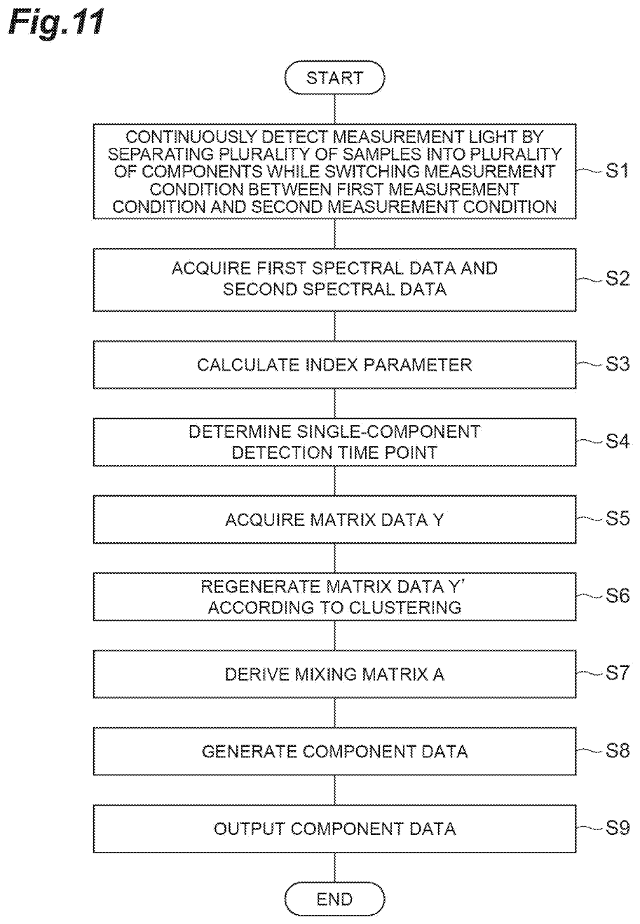

Next, an analysis procedure for a sample using the HPLC system 1 according to the present embodiment, i.e., a flow of a liquid chromatography method according to the present embodiment, will be described. FIG. 11 is a flowchart showing an analysis procedure of the HPLC system 1.

First, the HPLC system 1 separates a sample into a plurality of components, and temporally continuously detects fluorescence generated from the plurality of components for each of a plurality of measurement wavelengths while switching a measurement condition between a first measurement condition and a second measurement condition for the plurality of components obtained in the separation process (step S1, separation step, and detection step). Also, the analysis unit 13 of the HPLC system 1 acquires first matrix data Y₁ that is first spectral data on the basis of detection signals continuously output from the detection unit 11 under the first measurement condition, and acquires second matrix data Y₂ that is second spectral data on the basis of detection signals continuously output from the detection unit 11 under the second measurement condition (step S2 and start of analysis step).

Subsequently, the analysis unit 13 calculates an index parameter for each of N time points (step S3). Furthermore, the analysis unit 13 determines whether or not each time point is a single-component detection time point on the basis of the calculated index parameter (step S4). Also, the analysis unit 13 re-acquires the matrix data Y obtained in step S2 (step S5). The matrix data Y may be the first matrix data Y₁ or the second matrix data Y₂, or may be matrix data acquired on the basis of detection signals output from the detection unit 11 under another measurement condition.

Subsequently, the analysis unit 13 regenerates matrix data Y′ by clustering C array data items for each of a plurality of time points determined to be single-component detection time points included in the matrix data Y (step S6). Thereafter, the analysis unit 13 derives the mixing matrix A on the basis of the matrix data Y′ (step S7).

Also, the analysis unit 13 generates K component data items by unmixing the matrix data Y using the mixing matrix A (step S8). Finally, the analysis unit 13 outputs the K component data items (step S9 and end of analysis step). Thereby, analysis of the sample is completed.

According to the above-described HPLC system 1, a sample is separated into a plurality of components in the column 9 due to an interaction difference between the column 9 and the mobile phase 3, and measurement light for the plurality of components obtained in the separation process is detected using a plurality of measurement wavelengths, such that detection signals are output. Also, distributions of fluorescence intensity values for each of the N time points and each of the C measurement wavelengths are acquired as first matrix data Y₁ and second matrix data Y₂ on the basis of detection signals output under two measurement conditions, an index parameter for each time point is acquired on the basis of these two distributions, and it is determined whether each time point is a single-component detection time point on the basis of the acquired index parameter. Thereby, a temporal change in a measured value for each measurement wavelength can be accurately separated for each of a plurality of components included in the sample. As a result, it is possible to easily implement analysis of the plurality of components included in the sample.

Furthermore, according to the present embodiment, the matrix data Y is clustered into L time-point groups in which a single component is detected, a mixing matrix (separation information) is obtained from the clustered matrix data, and the matrix data Y is unmixed using the mixing matrix, such that component data representing a distribution for each of the K components is generated. As a result, even when measurement light for a plurality of components is simultaneously detected in an overlapping manner, distributions of values based thereon can be separated and analyzed, and temporal changes in distributions for the plurality of components included in the sample can be accurately acquired.

Moreover, according to the present embodiment, single-component detection time points are determined using the first matrix data Y₁ and the second matrix data Y₂, which are distributions of fluorescence intensity values obtained by changing wavelength characteristics of excitation light, thereby improving determination accuracy and enabling more accurate separation of a temporal change in a measurement value for each measurement wavelength for each of a plurality of components included in the sample.

Although various embodiments of the present invention have been described above, the present invention is not limited to the above-described embodiments, and may be modified or applied to other forms without departing from the scope of the matters set forth in the claims.

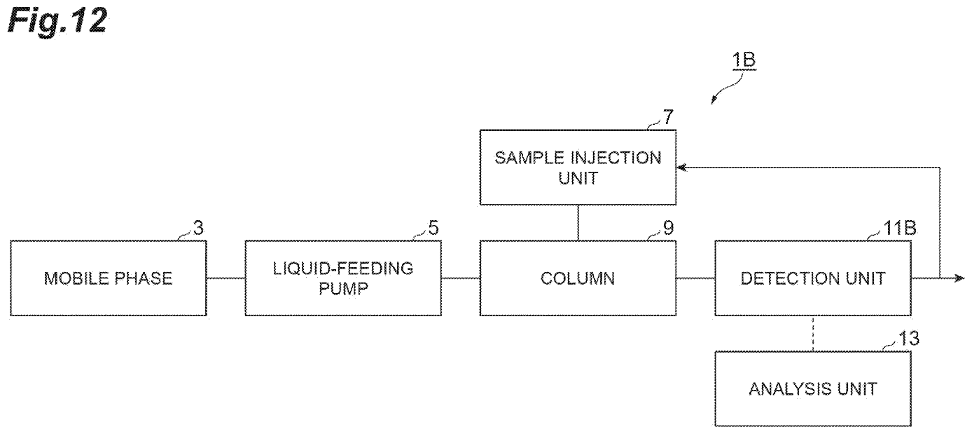

A configuration of the HPLC system 1 of the above-described embodiment may be replaced with that of an HPLC system 1B shown in FIG. 12. A difference between the HPLC system 1B shown in FIG. 12 and the HPLC system 1 is that a configuration in which a mobile phase including a plurality of components fed from the column 9 is collected after passing through a detection unit 11B, returned to the sample injection unit 7, and injected into the column 9 so that the mobile phase can be fed again toward the detection unit 11B and a configuration of the detection unit 11B itself are different.

In the modification example having the above-described configuration, the analysis unit 13 acquires first spectral data on the basis of detection signals output from the detection unit 11B for a plurality of components fed for the first time, and acquires second spectral data on the basis of detection signals output from the detection unit 11B for a plurality of components fed for the second time. Thereby, first spectral data and second spectral data can be acquired under a first measurement condition and a second measurement condition, respectively, for samples having different abundance ratios of a target substance and impurities.

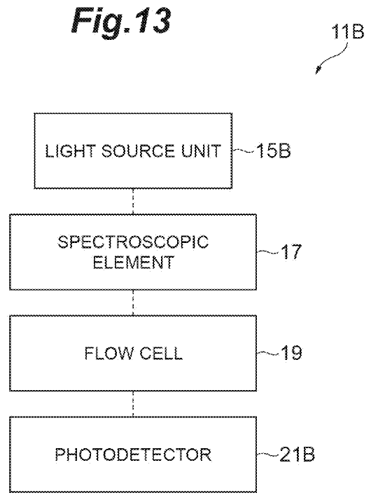

FIG. 13 shows a configuration of the detection unit 11B in the modification example. The detection unit 11B is used for measuring absorbance of components included in a sample. A light source unit 15B included in the detection unit 11B irradiates a plurality of components separated from the sample by the column 9 with irradiation light having a desired wavelength range including at least an ultraviolet wavelength range. For example, the light source unit 15B may be a light source device such as a deuterium (D2) lamp or a tungsten (W) lamp. The light source unit 15B may be a wavelength-variable light source or a wavelength-scanning light source that switches irradiation light among measurement wavelengths of a plurality of wavelength bands to radiate irradiation light in a predetermined single wavelength range (measurement wavelength) or the like. In this case, the spectroscopic element 17 may be omitted. In this modification example, irradiation light is incident on the flow cell 19 through which a mobile phase including a plurality of components passes, and irradiation light that has passed through the mobile phase including the plurality of components is emitted from the flow cell 19.

In this modification example, a photodetector 21B detects irradiation light transmitted through the flow cell 19 and outputs a detection signal indicating a transmitted light intensity of the irradiation light. The photodetector 21B may be, for example, a photodiode, an avalanche photodiode, a photomultiplier tube, or the like. The photodetector 21B detects transmitted light for each of a plurality of measurement wavelengths while the plurality of components flow through the flow cell 19, and outputs a detection signal for each of the plurality of measurement wavelengths. Because the fed mobile phase moves through the flow cell 19 over several tens of seconds to several minutes, detection signals for a plurality of measurement wavelengths can be output from the photodetector 21B by radiating irradiation light from the light source unit 15B according to switching among a plurality of measurement wavelengths during that period.

Moreover, in this modification example, the analysis unit 13 acquires first spectral data, which is a distribution of absorbance based on transmitted light intensities for each of N time points and each of C measurement wavelengths, on the basis of detection signals of a plurality of measurement wavelengths output continuously at predetermined time intervals from the photodetector 21B under the first measurement condition, similarly acquires second spectral data under the second measurement condition, and acquires K component data items by analyzing the spectral data as in the above-described embodiment.

In addition, in the above-described modification example, the analysis unit 13 acquires spectral data by calculating absorbance Ab according to the following formula using Lambert-Beer's law, on the basis of an incident light intensity E₀ of irradiation light incident on the flow cell 19 measured in advance, and a transmitted light intensity E based on a detection signal.

Ab=εCl=log(E₀/E)

In the above formula, ε denotes a molar absorptivity, C denotes a concentration, and l denotes an optical path length of the cell. For example, if it is assumed that a sample includes two components A and B, that a molar absorptivity of component A at a first measurement wavelength is denoted by ε_{A1}, a molar absorptivity of component B at the first measurement wavelength is denoted by ε_{B1}, a molar absorptivity of component A at a second measurement wavelength is denoted by ε_{A2}, a molar absorptivity of component B at the second measurement wavelength is denoted by ε_{B2}, a concentration of component A is denoted by C_{A}, a concentration of component B is denoted by C_{B}, an incident light intensity at the first measurement wavelength is denoted by E₀₁, and an incident light intensity at the second measurement wavelength is denoted by E₀₂, a transmitted light intensity E₁ at the first measurement wavelength and a transmitted light intensity E₂ at the second measurement wavelength are expressed by the following formulas.

E₁=E₀₁ exp(−(ε_{A1}C_{A}1+ε_{B1}C_{B}1))

E₂=E₀₂ exp(−(ε_{A2}C_{A}1+ε_{B2}C_{B}1))

If the above formulas are modified, an absorbance Ab₁ at the first measurement wavelength and an absorbance Ab₂ at the second measurement wavelength are expressed by the following matrix formula.

$$( \begin{matrix}{Ab}_{1} \\ {Ab}_{2}\end{matrix} ) = ( \begin{matrix}{ε}_{A 1} & {ε}_{B 1} \\ {ε}_{A 2} & {ε}_{B 2}\end{matrix} ) ( \begin{matrix}{C}_{A} l \\ {C}_{B} l\end{matrix} ) \qquad [ Math . 4 ]$$

Accordingly, it is understood that, by converting the transmitted light intensity into absorbance, a relationship between matrix data Y, which is an observation value matrix, and component matrix data X is represented using the above-described mixing matrix A.

According to the above modification example, determination accuracy is improved by determining single-component detection time points using the first spectral data and the second spectral data obtained with changed abundance ratios of included components, and temporal changes in measured values for each measurement wavelength can be more accurately separated for each of a plurality of components included in the sample. That is, according to the above-described modification example, single-component detection time points are determined using the second spectral data obtained with abundance ratios of included components changed from those of the components for the first spectral data through sample collection. Thereby, determination accuracy is improved, and a temporal change in a measurement value for each measurement wavelength can be more accurately separated for each of a plurality of components included in the sample.

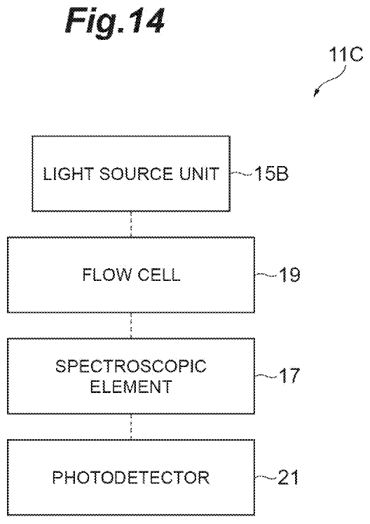

The detection unit 11B of the above-described modification example may be replaced with a detection unit 11C shown in FIG. 14. In the detection unit 11C, a spectroscopic element 17 is arranged on an optical path of transmitted light between the flow cell 19 and the photodetector 21. The spectroscopic element 17 receives transmitted light from the flow cell 19 and spectrally disperses and outputs transmitted light of a plurality of single wavelength ranges (measurement wavelengths). The photodetector 21 detects transmitted light (measurement light) for each of the plurality of measurement wavelengths spectrally dispersed by the spectroscopic element 17 and outputs detection signals indicating transmitted light intensities for the plurality of measurement wavelengths. In this modification example, the analysis unit 13 acquires first spectral data, which is a distribution of absorbance based on transmitted light intensities for each of N time points and each of C measurement wavelengths, on the basis of detection signals continuously output at predetermined time intervals from the photodetector 21 under the first measurement condition, similarly acquires second spectral data under the second measurement condition, and acquires K component data items by analyzing the spectral data as in the above-described embodiment.

Although switching from the first measurement condition to the second measurement condition is performed by circulating a mobile phase including the sample in the above-described modification example, samples having different component compositions may be injected from the sample injection unit 7 under the first measurement condition and the second measurement condition instead thereof. For example, a measurement target sample in which impurities are mixed with a target substance may be prepared, loaded into the sample injection unit 7, and injected into the column 9 under the first measurement condition, and a standard sample including only the target substance may be prepared, loaded into the sample injection unit 7, and injected into the column 9 under the second measurement condition. Alternatively, a measurement target sample in which impurities are mixed with a target substance may be prepared, loaded into the sample injection unit 7, and injected into the column 9 under the first measurement condition, and a mixed sample may be prepared by further adding the target substance to the measurement target sample, loaded into the sample injection unit 7, and injected into the column 9 under the second measurement condition. Even in such cases, determination accuracy is improved by determining single-component detection time points using the first spectral data and the second spectral data obtained with changed abundance ratios of included components (abundance ratios of the target substance and impurities).

Moreover, in another modification example, the first spectral data and the second spectral data may be acquired for a sample sampled at different process timings under the first measurement condition and the second measurement condition. According to such a modification example, when a sample in which an amount of impurities changes with a progress situation of a process such as a manufacturing process or an analysis process is used as an analysis target and the sample can be sampled at a plurality of timings during the process, the first spectral data and the second spectral data can be acquired in a state in which abundance ratios of included components (abundance ratios of a target substance and impurities) are changed, without changing the device configuration.

In the above-described embodiment and the above-described modification examples, the analysis unit 13 may estimate the number of components included in the sample on the basis of matrix data Y, and may acquire a mixing matrix on the basis of the estimated number of components. Specifically, the analysis unit 13 performs singular value decomposition on matrix data Y as shown in the following formula.

Y=USV^{T}

In the above formula, matrix U is C×C matrix data, matrix S is a C×N singular value matrix in which singular values are arranged in descending order, and V denotes N×N matrix data. Also, the analysis unit 13 extracts columns 1 to k (k is an integer equal to or greater than 1 and equal to or less than C) of matrix U, extracts columns 1 to k and rows 1 to k of matrix S, and extracts rows 1 to k of matrix V, and performs low-rank approximation with a separation number k (the following formula).

Yₖ=UₖSₖVₖ^{T}

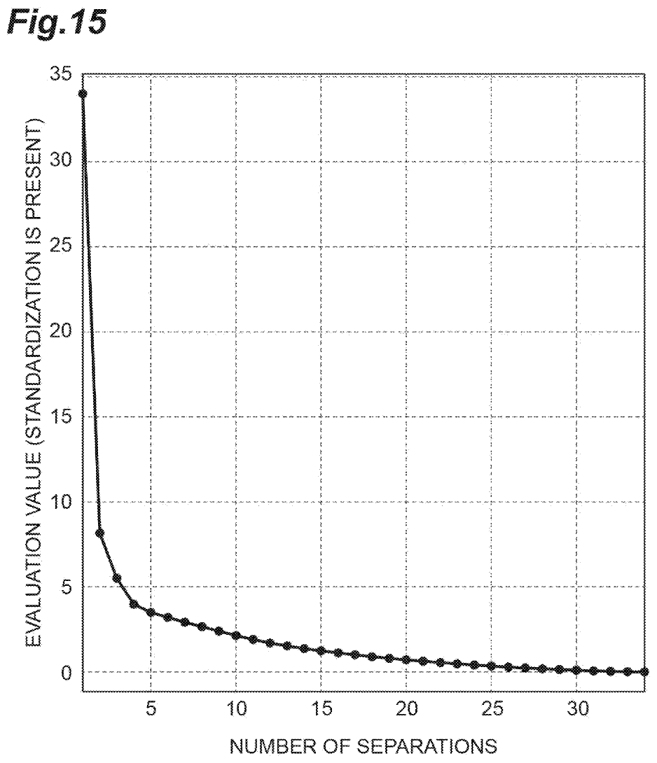

Furthermore, as shown in FIG. 15, the analysis unit 13 evaluates a squared error (evaluation value) of |Yₖ−UₖSₖVₖ^{T}|² when the value of k is varied from 1 to C and plots the squared error on a graph.

Subsequently, the analysis unit 13 can detect a portion at which the graph is most sharply bent using an elbow method, which is a method described in the paper “A Quantitative Discriminant Method of Elbow Point for the Optimal Number of Clusters in Clustering Algorithm”, and can estimate the separation number k corresponding to that portion as the number of components.

In the analysis unit 13 having the above function, even when the number of components included in the sample is unknown, the number of components can be estimated, and as a result, a temporal change in a distribution for each of an unknown number of components included in the sample can be acquired with high accuracy.

The parameter calculation unit 202 of the analysis unit 13 according to the above-described embodiment may calculate an index parameter metric2 for N time points using the following formula (2).

$$\begin{matrix}[ Math . 5 ] & \\ metric 2 = {\sum }_{i = 1}^{C} \frac{{( {r}_{i} - {r}_{ave} )}^{2}}{{σ}_{i}^{2}} & ( 2 )\end{matrix}$$

In formula (2), σᵢ denotes noise (standard deviation) of an intensity value for each of the C measurement wavelengths. That is, the parameter calculation unit 202 calculates the index parameter metric2 by dividing a difference between an intensity ratio of the C measurement wavelengths and an average value by noise at each measurement wavelength and then summing the results. According to such a variation example, it is possible to determine whether or not the N time points are single-component detection time points while taking measurement noise into consideration, and to prevent bias in determination accuracy of single-component detection time points among a plurality of components.

Moreover, the parameter calculation unit 202 of the analysis unit 13 may calculate an index parameter cos θ for the N time points using the following formula (3).

$$\begin{matrix}[ Math . 6 ] & \\ cos θ = \frac{\vec{a} \cdot \vec{b}}{\vert \vec{a} \vert \vert \vec{b} \vert} & ( 3 )\end{matrix}$$

In formula (3), a^{→} denotes first vector data that is a vector having, as elements, intensity values for the C measurement wavelengths included in the first spectral data, b^{→} denotes second vector data that is a vector having, as elements, intensity values for the C measurement wavelengths included in the second spectral data, and the index parameter cos θ denotes a cosine of an angle θ formed by the two vectors in a C-dimensional space. In this case, the determination unit 203 determines a time point at which the index parameter cos θ is equal to or greater than a threshold as a single-component detection time point, and determines that a time point at which the index parameter cos θ is less than the threshold is not a single-component detection time point.

Moreover, the parameter calculation unit 202 may calculate the angle θ formed by two vectors as an index parameter using the following formula (4). In this case, the determination unit 203 determines a time point at which the index parameter θ is equal to or less than a threshold as a single-component detection time point, and determines that a time point at which the index parameter θ is greater than the threshold is not a single-component detection time point.

$$\begin{matrix}[ Math . 7 ] & \\ θ = {cos}^{- 1} \frac{\vec{a} \cdot \vec{b}}{\vert \vec{a} \vert \vert \vec{b} \vert} & ( 4 )\end{matrix}$$

Moreover, when a statistical value is calculated for each time-point group of clustered cluster matrices, the statistical value calculation unit 205 of the analysis unit 13 may calculate the statistical value by weighting an intensity value of each time point according to a degree of determination for that time point (for example, using an index parameter). In such a case, a mixing matrix can be obtained using the degree of determination, and an amount of each component present at a time point can be obtained with higher accuracy.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A liquid chromatography device comprising:
a liquid-feeder configured to feed a mobile phase;
a column configured to separate a sample into a plurality of components, wherein the mobile phase is introduced into the column from the liquid-feeder;
a sample injector configured to inject the sample into the column;
a detector configured to detect, using a plurality of measurement wavelengths, measurement light derived from the plurality of components obtained in a separation process of the column, and to output detection signals; and
circuitry configured to analyze the detection signals,
wherein the circuitry is configured to:
acquire first spectral data representing a distribution of values based on the measurement light for each of N (N is an integer of 2 or more) time points and each of C (C is an integer of 2 or more) measurement wavelengths on the basis of the detection signals output under a first measurement condition;
acquire second spectral data representing a distribution of values based on the measurement light for each of the N time points and each of the C measurement wavelengths on the basis of the detection signals output under a second measurement condition; and
determine whether the measurement light is detected for a single component or not at a detection time point based on the first spectral data and the second spectral data.

2. The liquid chromatography device according to claim 1,
wherein the circuitry is configured to:
calculate an index parameter on the basis of the first spectral data and the second spectral data at the plurality of measurement wavelengths and at the detection time point; and
determine whether the measurement light is detected for a single component or not at the detection time point according to the index parameter.

3. The liquid chromatography device according to claim 2,
wherein the circuitry is configured to calculate the index parameter on the basis of ratios between the values at the plurality of measurement wavelengths in the first spectral data and the values at the plurality of measurement wavelengths in the second spectral data.

4. The liquid chromatography device according to claim 3,
wherein the circuitry is configured to calculate the index parameter by summing values obtained by subtracting an average value of the ratios from the ratios at the plurality of measurement wavelengths.

5. The liquid chromatography device according to claim 2,
wherein the circuitry is configured to determine that the measurement light is detected for a single component at the detection time point when the index parameter is equal to or less than a threshold.

6. The liquid chromatography device according to claim 1,
wherein the circuitry is configured to:
cluster spectral data at single-component detected time points into L (L is an integer equal to or greater than 2 and equal to or less than N−1) time-point groups, wherein the single-component detected time points are time points determined to be time points at which the measurement light is detected for a single component, and wherein the spectral data include the first spectral data or the second spectral data;
obtain separation information for calculating a distribution of each of K (K is an integer equal to or greater than 2 and equal to or less than C) components of the spectral data using the clustered spectral data; and
generate K sets of component data indicating the distribution of each of the K components by unmixing the spectral data using the separation information.

7. The liquid chromatography device according to claim 4,
wherein the circuitry is configured to:
cluster spectral data at single-component detected time points into L (L is an integer equal to or greater than 2 and equal to or less than N−1) time-point groups on the basis of the average value of the ratios at the plurality of measurement wavelengths, wherein the single-component detected time points are time points determined to be time points at which the measurement light is detected for a single component, and wherein the spectral data include the first spectral data or the second spectral data;
obtain separation information for calculating a distribution of each of K (K is an integer equal to or greater than 2 and equal to or less than C) components of the spectral data using the clustered spectral data; and
generate K sets of component data indicating the distribution of each of the K components by unmixing the spectral data using the separation information.

8. The liquid chromatography device according to claim 7,
wherein the circuitry is configured to cluster the spectral data into the L time-point groups using a k-means method.

9. The liquid chromatography device according to claim 6,
wherein the circuitry is configured to:
generate matrix data by compressing the spectral data in units of the L time-point groups; and
obtain the separation information using the matrix data.

10. The liquid chromatography device according to claim 9,
wherein the circuitry is configured to:
calculate a statistical value of the values included in the L time-point groups of the spectral data; and
generate the matrix data including the statistical value.

11. The liquid chromatography device according to claim 10,
wherein the statistical value is an average value of the values, a mode value of the values, or a median value of the values.

12. The liquid chromatography device according to claim 9,
wherein the circuitry is configured to:
set an initial value of a candidate mixing matrix;
calculate loss values while sequentially changing values of the candidate mixing matrix from the initial value, wherein the loss value is a difference between the matrix data and the distribution of each of the K components calculated from the matrix data and the candidate mixing matrix; and
identify the candidate mixing matrix having a value that reduces a loss value as the separation information.

13. The liquid chromatography device according to claim 1,
wherein the circuitry is configured to acquire the first spectral data and the second spectral data for the sample while changing a ratio between a target substance and an impurity for each of the first measurement condition and the second measurement condition.

14. The liquid chromatography device according to claim 1, wherein the second measurement condition is a measurement condition under which the detector detects the measurement light in a state in which the sample serving as a detection target under the first measurement condition is collected and returned to the sample injector and injected into the column.

15. The liquid chromatography device according to claim 1, further comprising:
a light source configured to irradiate the plurality of components obtained in the separation process of the column with first excitation light having a first excitation wavelength characteristic and second excitation light having a second excitation wavelength characteristic while switching between the first excitation light and the second excitation light; and
a spectroscopic element configured to spectrally disperse fluorescence from the plurality of components generated by the first excitation light and the second excitation light for each of a plurality of fluorescence wavelengths,
wherein the detector detects the fluorescence spectrally dispersed at each of the plurality of fluorescence wavelengths as the measurement light, and
wherein the circuitry is configured to:
acquire the first spectral data representing a distribution of fluorescence intensity values for each of the N time points and each of C fluorescence wavelengths on the basis of detection signals during irradiation with the first excitation light;
acquire the second spectral data representing a distribution of fluorescence intensity values for each of the N time points and each of the C fluorescence wavelengths on the basis of detection signals during irradiation with the second excitation light; and
analyze the first spectral data and the second spectral data.

16. The liquid chromatography device according to claim 6,
wherein the circuitry is configured to:
calculate an evaluation value on the basis of the spectral data while changing a value of K; and
estimate a number of components on the basis of the evaluation value.

17. A liquid chromatography method comprising:
feeding a mobile phase;
injecting a sample into a column;
introducing the mobile phase into the column;
separating the sample into a plurality of components;
detecting, using a plurality of measurement wavelengths, measurement light derived from the plurality of components obtained in a separation process of the column;
outputting detection signals; and
analyzing the detection signals,
wherein the analyzing comprises:
acquiring first spectral data representing a distribution of values based on the measurement light for each of N (N is an integer of 2 or more) time points and each of C (C is an integer of 2 or more) measurement wavelengths on the basis of the detection signals output under a first measurement condition;
acquiring second spectral data representing a distribution of values based on the measurement light for each of the N time points and each of the C measurement wavelengths on the basis of the detection signals output under a second measurement condition; and
determining whether the measurement light is detected for a single component or not at a detection time point based on the first spectral data and the second spectral data.

18. The liquid chromatography method according to claim 17,
wherein the analyzing comprises:
calculating an index parameter on the basis of the first spectral data and the second spectral data at the plurality of measurement wavelengths and at the detection time point; and
determining whether the measurement light is detected for a single component or not at the detection time point according to the index parameter.
